(19) United States
(12) Patent Application Publication
(10) Pub. No.: US 2026/0182734 A1
(43) Pub. Date: Jul. 2, 2026

(54) ADJUSTABLE TABLE

(71) Applicant: Virco Mfg. Corporation, Torrance, CA (US)

(72) Inventors: Roger Rosales, Torrance, CA (US); Man F. Hui, Monterey Park, CA (US)

(21) Appl. No.: 19/430,025

(22) Filed: Dec. 22, 2025

Related U.S. Application Data
(60) Provisional application No. 63/740,671, filed on Dec. 31, 2024.

(51) Int. Cl. A47B 9/08; A47B 9/20; F16B 7/14

(52) U.S. Cl. CPC A47B 9/08; A47B 9/20; F16B 7/1454

(57) ABSTRACT

Disclosed herein are various systems for an adjustable height table with a clamping mechanism. The system may include a leg assembly comprising: an upper leg connected to the table member; and a lower leg, the lower leg shaped and sized to at least partially fit within the upper leg as the upper leg travels along an axis defined by the lower leg. The system may include a clamp assembly comprising: a housing coupled to the upper leg, the housing shaped and sized to at least partially surround the upper leg; and a lever connected to the housing, the lever selectively rotatable between a first engaged position and a second disengaged position. The upper leg and the table member can be moved along the axis when the lever is in the second disengaged position, and can be not movable along the axis when the lever is in the first engaged position.

### CROSS REFERENCE TO RELATED APPLICATIONS

This application claims priority to U.S. Provisional Ser. No. 63/740,671, filed on Dec. 31, 2025, the entire contents of which are incorporated herein by reference in its entirety. Any and all applications for which a foreign or domestic priority claim is identified in the Application Data Sheet of the present application is hereby incorporated by reference under 37 CFR 1.57.

### BACKGROUND OF THE INVENTION

### Field of the Invention

The present disclosure generally relates to an adjustable table, namely an adjustable height table.

### Description of the Related Art

Adjustable height tables and furniture can suffer from issues of cost, weight, and complexity. Adjustable height tables often require one or more motors or pneumatic systems to raise and lower the table, along with electronic components. These systems may increase the overall cost and weight of the tables, as well as increase the complexity of manufacturing. Furthermore, these systems can be limited in their portability or transportation, as the systems may require connection to a power supply to provide energy for the system to raise and/or lower the table surface. Some adjustable height tables can be cumbersome and difficult to move and install, which can be unappealing to some consumers. The motors and electronic systems can increase the overall complexity of the adjustable height tables, increasing the risk of malfunction or breakage.

### SUMMARY OF THE INVENTION

Disclosed herein are embodiments of an adjustable height table that can be adjusted without the need of any powered assistance. The height of the table can be adjusted to have its table surface rest at a variety of heights.

In some embodiments, the techniques described herein relate to a table including: a table member; a leg assembly including: a upper leg connected to the table member; and a lower leg, the lower leg shaped and sized to at least partially fit within the upper leg as the upper leg travels along an axis defined by the lower leg; and a clamp assembly including: a housing coupled to the upper leg, the housing shaped and sized to at least partially surround the upper leg; and a lever connected to the housing, the lever selectively rotatable between a first engaged position and a second disengaged position; wherein the upper leg and the table member are movable along the axis when the lever is in the second disengaged position, and wherein the upper leg and the table member are not movable along the axis when the lever is in the first engaged position.

In some embodiments, the techniques described herein relate to a table, wherein the lever includes a surface, the surface configured to contact a surface of the lower leg when the lever is rotated to the engaged position.

In some embodiments, the techniques described herein relate to a table, wherein the surface includes a protrusion, the protrusion configured to contact the surface of the lower leg when the lever is rotated to the engaged position.

In some embodiments, the techniques described herein relate to a table, wherein the lever presses the lower leg against the upper leg when the lever is in the engaged position.

In some embodiments, the techniques described herein relate to a table, wherein the clamp assembly pulls the upper leg against the lower leg when the lever is in the engaged position.

In some embodiments, the techniques described herein relate to a table, wherein the table member is configured to move along the axis without motors, electronics, or pneumatics.

In some embodiments, the techniques described herein relate to a table, wherein, when the lever is in the first engaged position, the position of the table member is maintained solely by frictional force between: the upper leg and lower leg; and the lever and the lower leg.

In some embodiments, the techniques described herein relate to a table, wherein the table further includes a retention assembly attached to the table member, the retention assembly including a hook configured to limit the vertical movement of the table member.

In some embodiments, the techniques described herein relate to a table including: a table member; a telescoping leg assembly including: a lower leg coupled to a frame to support the table; and an upper leg coupled to the table member, the upper leg configured to move along an axis defined by the lower leg to adjust a height of the table member, the upper leg configured to at least partially surround the lower leg as the upper leg is moved along the axis; and a clamp assembly including: a housing coupled to the upper leg, wherein the housing at least partially surrounds the upper leg and the lower leg; and a lever coupled to the housing, the lever selectively rotatable between an engaged position and a disengaged position; wherein the upper leg and the table member are freely movable along the axis when the lever is in the disengaged position, wherein movement of the upper leg and the table member is resisted along the axis when the lever is in the engaged position.

In some embodiments, the techniques described herein relate to a table, wherein an engagement surface of the lever further includes a protrusion configured to contact the outer surface of the lower leg when the lever is rotated to the engaged position, wherein the protrusion further resists movement of the upper leg and table member along the axis.

In some embodiments, the techniques described herein relate to a table, wherein the clamp assembly simultaneously presses the lower leg against the upper leg and pulls the upper leg against the lower leg when the lever is in the engaged position to resist movement of the upper leg and table member along the axis.

In some embodiments, the techniques described herein relate to a table, wherein the table member and upper leg are configured to move along the axis without motors, electronics, or pneumatics.

In some embodiments, the techniques described herein relate to a table, wherein, when the lever is in the engaged position, the position of the table member is maintained solely by frictional force between: the upper leg and the lower leg; and the lever and the lower leg.

In some embodiments, the techniques described herein relate to a table, further including a retention assembly configured to engage a portion of the lower leg to limit a maximum vertical movement of the table member.

In some embodiments, the techniques described herein relate to a table, wherein the retention assembly includes a hook configured to move with the table member and upper leg, the hook configured to catch a protrusion of the lower leg to limit the maximum vertical movement of the table member.

In some embodiments, the techniques described herein relate to a table, wherein the lower leg includes a groove extending along a length of the lower leg, and the housing includes a housing protrusion configured to be received in the groove to limit rotational movement between the upper leg and the lower leg.

In some embodiments, the techniques described herein relate to a table including: a table member; a telescoping leg assembly including: a first leg coupled to the table member; and a second leg coupled to a support frame, the second leg shaped and sized to at least partially fit within the first leg as the first leg moves relative to the second leg; and a locking assembly including: a sleeve configured to at least partially surround the first leg and the second leg; and an lever coupled to the sleeve, the lever movable between an engaged and a disengaged position; wherein the first leg and the second leg are freely movable relative to each other when the lever is in the disengaged position, and wherein relative movement between the first leg and the second leg is prevented when the lever is in the engaged position to set a height of the table.

In some embodiments, the techniques described herein relate to a table, wherein the lever includes an engagement surface including a detent mechanism, the engagement surface and detent mechanism configured to contact an outer surface of the second leg when the lever is in the engaged position to prevent relative movement between the first leg and the second leg.

In some embodiments, the techniques described herein relate to a table, wherein the second leg includes a plurality of surface features configured to contact the engagement surface and the detent mechanism when the lever is in the engaged position to increase a frictional force between the second leg and the lever.

In some embodiments, the techniques described herein relate to a table, wherein the locking assembly simultaneously presses the second leg against the first leg and pulls the first leg against the second leg when the lever is in the engaged position to prevent relative movement between the first leg and the second leg.

In some embodiments, the techniques described herein relate to a table, further including a retention assembly configured to limit a maximum height of the table, the retention assembly configured to move with either the first leg or the second leg and configured to engage with a portion of the other of the first leg or the second leg when the table is moved to the maximum height to prevent further movement of the first leg and the second leg away from each other.

In some embodiments, the techniques described herein relate to a table, wherein the first leg includes a groove extending along a length of the second leg, and the sleeve includes a sleeve protrusion configured to be received in the groove to limit rotational movement between the second leg and the first leg.

In some embodiments, the techniques described herein relate to an adjustable height furniture including: a telescoping leg assembly configured to adjust a height of the furniture, the telescoping leg assembly including: a first leg; and a second leg; and a locking assembly including: a housing coupled to the second leg; and an lever movable between an engaged position and a disengaged position; wherein the first leg and the second leg are free to move relative to each other when the lever is in the disengaged position, and wherein relative movement between the first leg and the second leg is prevented when the lever is in the engaged position.

In some embodiments, the techniques described herein relate to a furniture, wherein the lever includes an engagement surface configured to contact an outer surface of the second leg when the lever is in the engaged position to prevent relative movement between the first leg and the second leg.

In some embodiments, the techniques described herein relate to a furniture, wherein the engagement surface includes a protrusion configured to contact the outer surface of the second leg when the lever is in the engaged position to prevent relative movement between the first leg and the second leg.

In some embodiments, the techniques described herein relate to a furniture, wherein the locking assembly simultaneously presses the second leg against the first leg and pulls the first leg against the second leg when the lever is in the engaged position to prevent relative movement between the first leg and the second leg.

In some embodiments, the techniques described herein relate to a furniture, further including a retention assembly configured to limit a maximum height of the furniture, the retention assembly configured to move with either the first leg or the second leg and configured to engage with a portion of the other of the first leg or the second leg when the furniture is moved to the maximum height to prevent further movement of the first leg and the second leg away from each other.

In some embodiments, the techniques described herein relate to a furniture, wherein the first leg includes a groove extending along a length of the second leg, and the housing includes a housing protrusion configured to be received in the groove to prevent rotational movement between the second leg and the first leg.

### BRIEF DESCRIPTION OF THE DRAWINGS

Throughout the drawings, reference numbers are re-used to indicate correspondence between referenced elements. The drawings are provided to illustrate embodiments of the subject matter described herein and do not limit the scope thereof.

FIG. 1A illustrates a perspective view of an embodiment of a table in a locked position at a first height.

FIG. 1B illustrates a perspective view of the embodiment of the table of FIG. 1A in an unlocked position.

FIG. 1C illustrates a perspective view of the embodiment of the table of FIG. 1A in a locked position at a second height.

FIG. 2 illustrates a bottom perspective view of the embodiment of the table of FIG. 1A.

FIG. 3 illustrates a front view of the embodiment of the table of FIG. 1A.

FIG. 4 illustrates a rear view of the embodiment of the table of FIG. 1A.

FIG. 5 illustrates a first side view of the embodiment of the table of FIG. 1A.

FIG. 6 illustrates a second side view of the embodiment of the table of FIG. 1A.

FIG. 7 illustrates a top view of the embodiment of the table of FIG. 1A.

FIG. 8 illustrates a bottom view of the embodiment of the table of FIG. 1A.

FIG. 9 illustrates a front view of an embodiment of a clamp assembly of a table.

FIG. 10 illustrates a side view of an embodiment of a clamp assembly of a table.

FIG. 11 illustrates a cross-sectional side view of an embodiment of a clamp assembly of a table in a first, engaged position.

FIG. 12 illustrates a cross-sectional side view of an embodiment of a clamp assembly of a table in a second, disengaged position.

FIG. 13 illustrates a cross-sectional top view of an embodiment of a clamp assembly of a table in a first position.

FIG. 14 illustrates a cross sectional front view of an embodiment of a retention assembly of a table.

FIG. 15 illustrates a perspective view of an embodiment of a table.

FIG. 16 illustrates a perspective view of an embodiment of a table.

FIG. 17 illustrates a perspective view of an embodiment of a table.

### DETAILED DESCRIPTION OF THE PREFERRED EMBODIMENT

There exists a need for an adjustable height table and furniture that is low cost, lightweight, portable, and has a low risk of malfunction or breakage. Disclosed herein are various embodiments of adjustable height furniture, particularly tables, that can be moved and utilized more easily than conventional adjustable height furniture. While the present disclosure primarily describes an adjustable height table, the concepts and systems disclosed herein may also be implemented in other furniture or systems that can benefit from adjusting lengths of any portion.

Disclosed herein are various embodiments of an adjustable height table designed to have a table member attached to a leg assembly. The height of the table can be adjusted by operation of a clamp assembly positioned on the leg assembly. The clamp assembly can secure the table in place vertically and can prevent movement of the table member relative to the table feet.

### Adjustable Height Table Overview

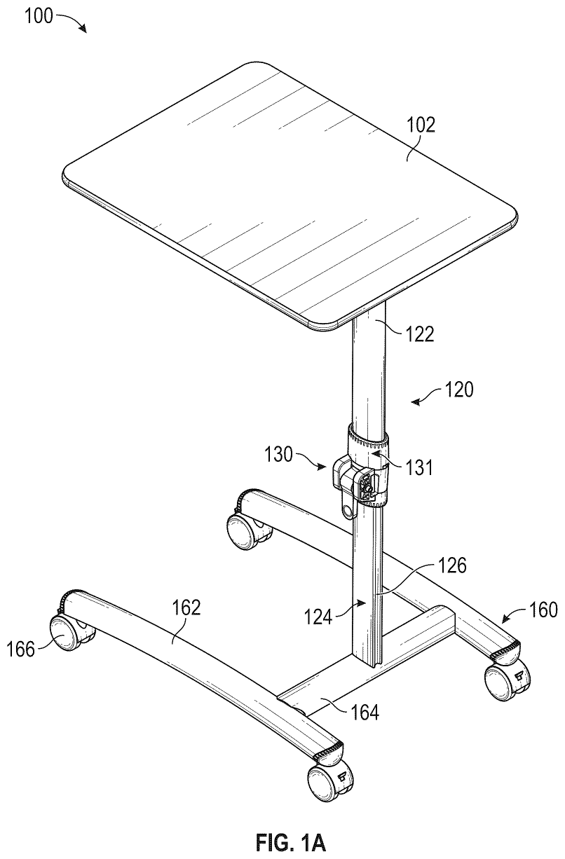

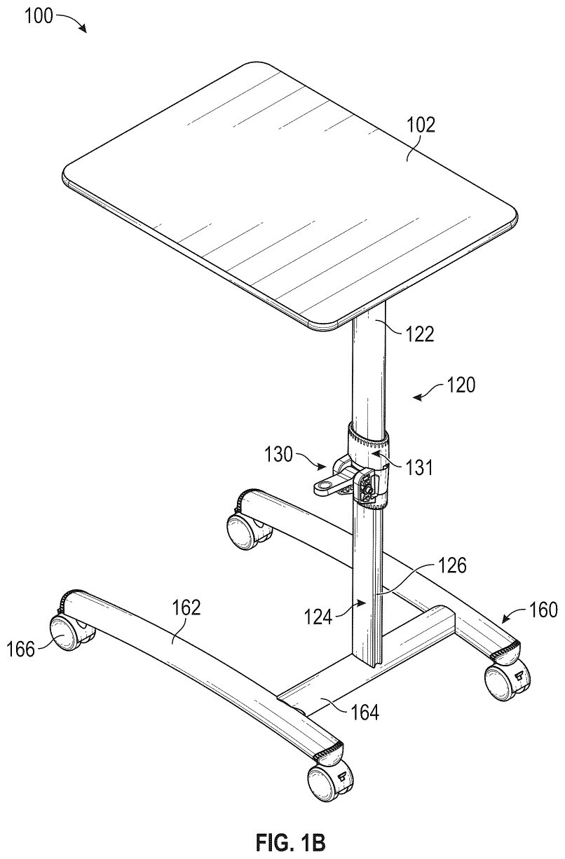

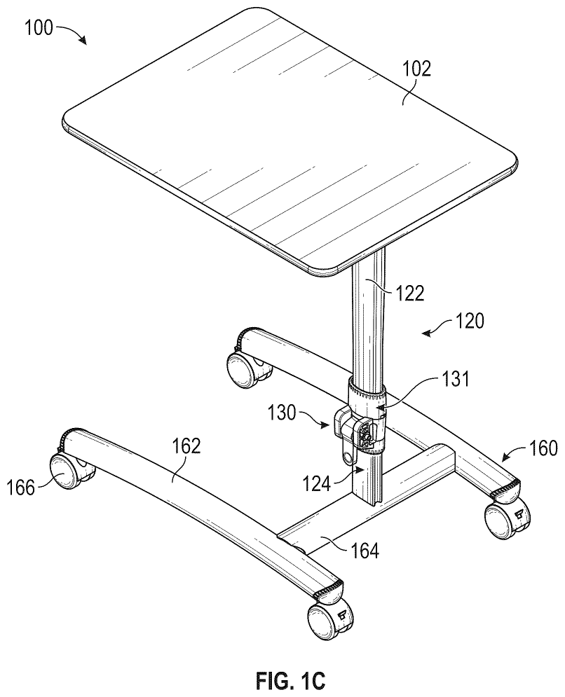

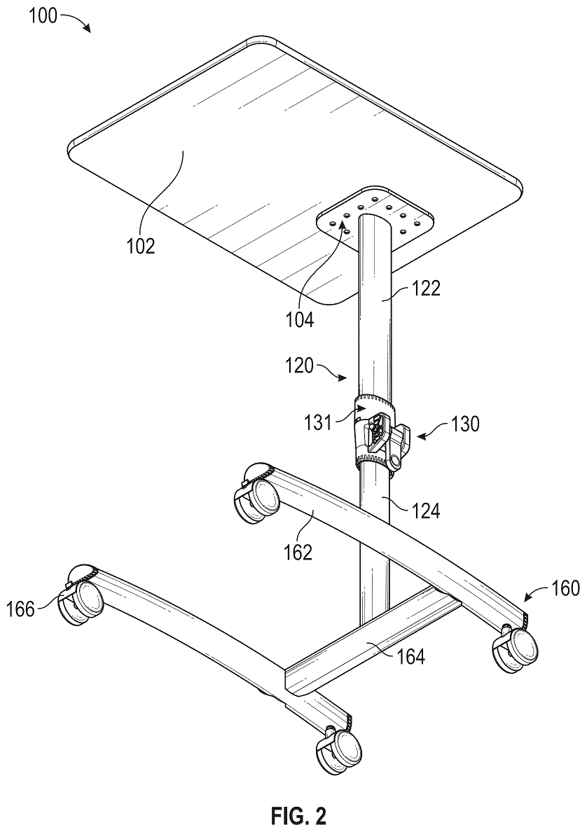

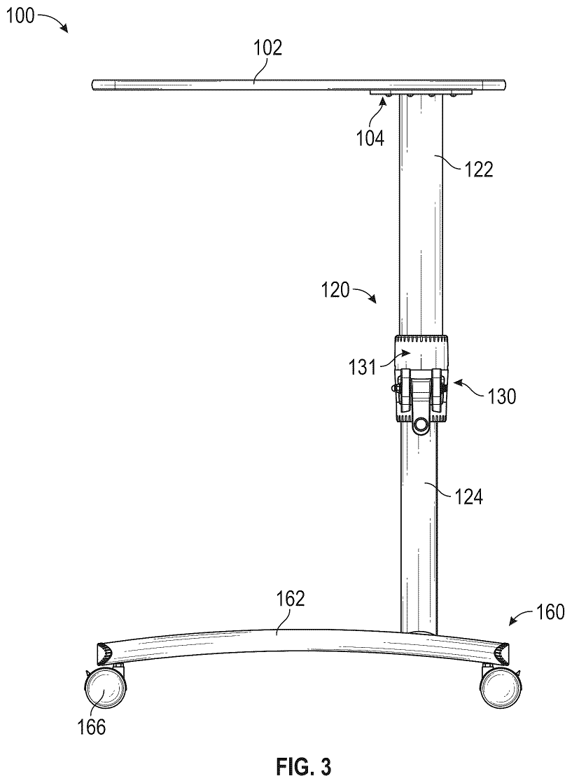

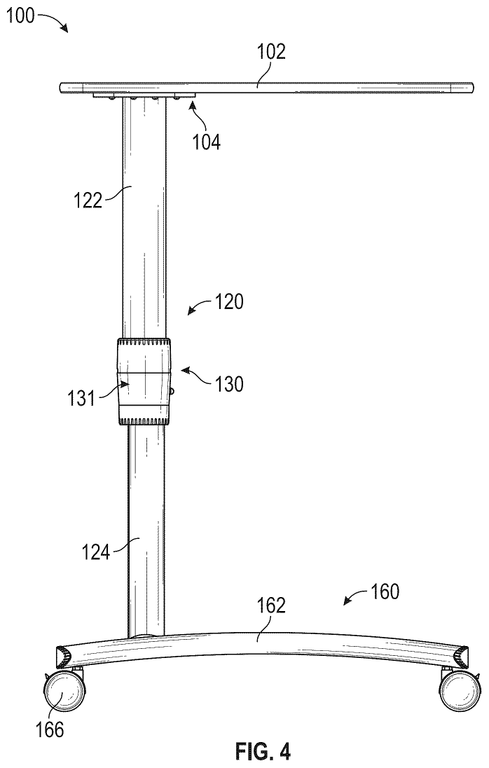

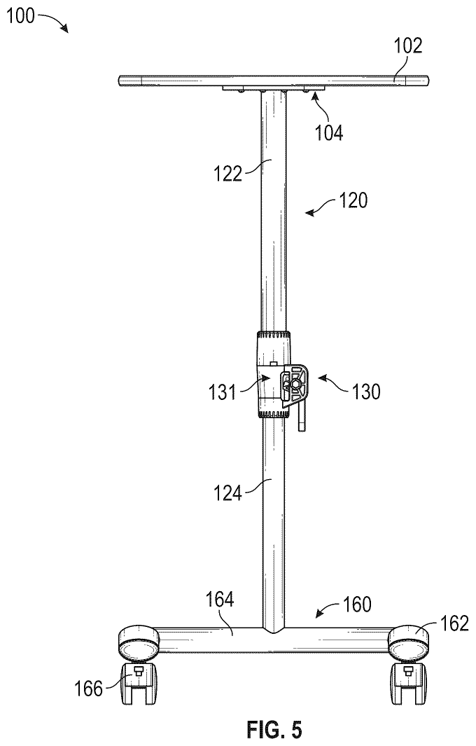

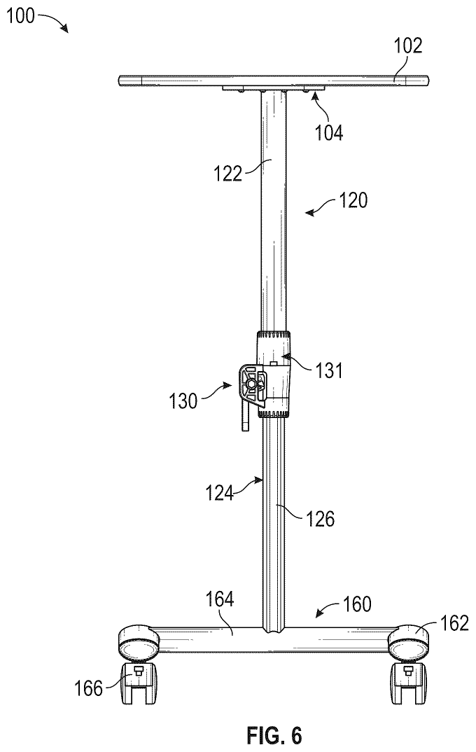

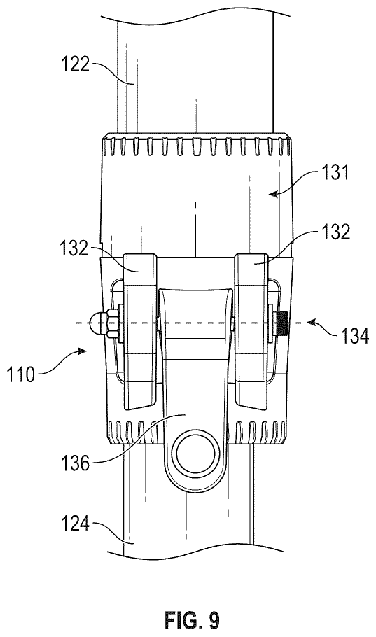

FIGS. 1A-14 depict various views of an embodiment of a table 100 that is arranged and configured in accordance with certain features, aspects, and advantages of the present disclosure. The table 100 may include a table member 102 (e.g., table surface) that can be movable to different heights, a leg assembly 120 (e.g., telescoping leg assembly) to support the table member 102 and/or guide the movement of the table member 102 to different heights, a clamp assembly 130 (e.g., securement assembly, locking assembly) to set (e.g., secure, lock, vary, adjust, customize) the height of the table member 102 at various different heights, and/or a frame 160 (e.g. support frame, leg structure, support structure) to support the table member 102 and the leg assembly 120 within one or more different embodiments as disclosed herein. In some embodiments, the table 100 may include a retention assembly 180 to limit the maximum vertical movement of the table member 102 and the maximum height of the table 100.

The leg assembly 120 can include an upper leg 122 (e.g., first leg, first portion), which connects to the table member 102, and a lower leg 124 (e.g., second leg, second portion) which connects to the frame 160 to support the table 100. The upper leg 122 may move with the table member 102 as the height of the table member 102 is adjusted. The lower leg 124 may at least partially fit within the upper leg 122 as the height of the table 100 is adjusted. The upper leg 122 and lower leg 124 can be arranged such that as the height of the table member 102 is adjusted (e.g., decreased, shortened), the lower leg 124 can move into the upper leg 122. In some embodiments, the orientation and/or size of the upper leg 122 and the lower leg 124 can be reversed such that the upper leg 122 can at least partially fit within the lower leg 124 as the height of the table member 102 is adjusted.

The clamp assembly 130 can include a housing 131 to couple a lever 136 (e.g., actuator, handle, switch) to the leg assembly 120. Operation of the lever 136 can selectively contact or engage with a portion of the leg assembly 120 to limit, substantially prevent, and/or prevent movement of the table member 102 relative to the frame 160 and/or a floor surface supporting the table 100. For example, the lever 136 may selectively engage or disengage from the lower leg 124 to limit or allow adjustment of the height of the table member 102.

The frame 160 can include one or more feet 162 to stabilize the table 100, a support member 164 to connect the one or more feet 162 to the leg assembly 120, and/or one or more wheels to permit the table 100 to roll.

### Table Member

In the embodiment illustrated in FIGS. 1A-14, the table member 102 is generally planar and substantially horizontal to the ground. In some embodiments, the table member 102 may be angled to the ground or may be nonplanar.

As illustrated, the table member 102 has a generally rectangular shape with rounded corners. Any other combination of sides or shapes of the table member 102 can also be used. For example, the table member 102 could be circular in shape or the table member 102 may have sharp corners. The table member 102 may be made of wood, metal, laminate material, or any other appropriate material. The table member 102 can be generally parallel to the floor surface upon which the table 100 rests. In some embodiments, the table member 102 can be angled relative to the floor. In some embodiments, the angle of the table member 102 relative to the floor can be adjusted.

The table member 102 can be fixedly attached and/or connected to the leg assembly 120 at the upper leg 122. The table member 102 can be connected to the leg assembly 120 by an attachment plate 104, which may be unitarily formed with the upper leg 122. In some embodiments, the table member 102 may be connected to the upper leg 122 directly. The table member 102 may be connected to the upper leg 122 by welding, mechanical coupling, such as by mechanical fasteners, or any other appropriate means. The upper leg 122 may be connected to the table member 102 near a center of the table member 102 or at a point offset from a center of the table member 102. For example, in the embodiment shown in FIGS. 1A-14, the upper leg 122 is connected to the table member 102 at a point offset from the center of table member 102. The center of mass of the table member 102 can be positioned above a point within the perimeter defined by the frame 160 to advantageously increase stability of the table 100 and reduce the likelihood that the table tips over or becomes unbalanced when weight is placed on the table 100. The offset of the table member 102 can create more open space underneath the table member 102 which may allow a user to more easily fit a chair and/or their legs underneath the table member 102.

The table member 102 may move along a substantially vertical path in order to change the height of the table member 102. In some embodiments, the table member 102 may move along an axis defined by the leg assembly 120 (e.g., the lower leg 124). The axis may be substantially vertical to the ground. In some embodiments, the axis may be angled relative to the ground such that adjusting the height of the table also adjusts the horizontal position of the table member 102 relative to the frame 160.

### Leg Assembly

The leg assembly 120 can include an upper leg 122 and a lower leg 124. The table member 102 may be fixedly attached and/or connected to an upper leg 122 such that the table member 102 and the upper leg 122 move together as the height of the table member 102 is adjusted. The upper leg 122 can at least partially surround the lower leg 124. The upper leg 122 and table member 102 can move along an axis defined by the lower leg 124. The upper leg 122 may move and/or slide along an outer surface of the lower leg 124. The upper leg 122 may travel a length of the lower leg 124 such that the height of the table member 102 changes as the upper leg 122 travels a length of the lower leg 124. The lower leg 124 can be oriented substantially vertically relative to the frame 160 and/or the ground such that adjustment of the height of the table member 102 is done in a substantially vertical manner. This may advantageously allow the table member 102 to remain substantially parallel to the ground as its height is changed. In some embodiments, the leg assembly 120 can be angled relative to vertical such that adjustment of the height of the table 100 also adjusts a horizontal position of the table member 102 relative to the frame 160.

The lower leg 124 can be sized and shaped to at least partially fit within the upper leg 122. As the height of the table 100 is adjusted, the upper leg 122 can move relative to the lower leg 124. The upper leg 122 can entirely circumscribe the lower leg 124. In some embodiments, the upper leg 122 may alternatively be sized and shaped to at least partially fit within an interior of the lower leg 124 as the upper leg 122 moves along a length of the lower leg 124. The upper leg 122 and/or lower leg 124 may be at least partially hollow. The lower leg 124 may restrict the direction of movement of the upper leg 122 along a single axis (e.g., in a vertical direction) as the height of the table member 102 is adjusted.

In the embodiment illustrated in FIGS. 1A-14, the upper leg 122 and lower leg 124 have generally oblong cross sections. However, any other combination of shapes and sizes of cross sections can be used for the upper leg 122 and/or the lower leg 124, such as rectangular or circular. In some embodiments, the upper leg 122 may have a different cross-sectional shape from the cross-sectional shape of the lower leg 124. In some embodiments, the cross-sectional shape and/or dimensions of the upper leg 122 may vary over its length. In some embodiments, the cross-sectional shape and/or dimensions of the lower leg 124 may vary over its length.

The lower leg 124 can include a groove 126 shaped to fit a protrusion 146 of a housing 131 (e.g., sleeve) as described further herein, to help with alignment of the table member 102. In some embodiments, the groove 126 may extend the length of the lower leg 124. The lower leg 124 may include more than one groove 126. The groove 126 may be positioned along the length of the lower leg 124, such as on one or more sides of the lower leg 124.

The lower leg 124 may be fixedly attached and/or connected to a frame 160 to support the leg assembly 120 and increase the stability of the table member 102 as further described herein. The lower leg 124 may be fixedly attached and/or connected to the frame 160 by welding, mechanical fastening such as use of a threaded fastener, or any other appropriate means. In some embodiments, other portions of the leg assembly 120 may alternatively be connected to the frame 160.

The leg assembly 120 may be fixedly attached and/or connected to a clamp assembly 130. The clamp assembly 130 may be connected by welding, mechanical fastening such as use of a threaded fastener, glue, friction fitting, or any other appropriate means.

### Clamp Assembly

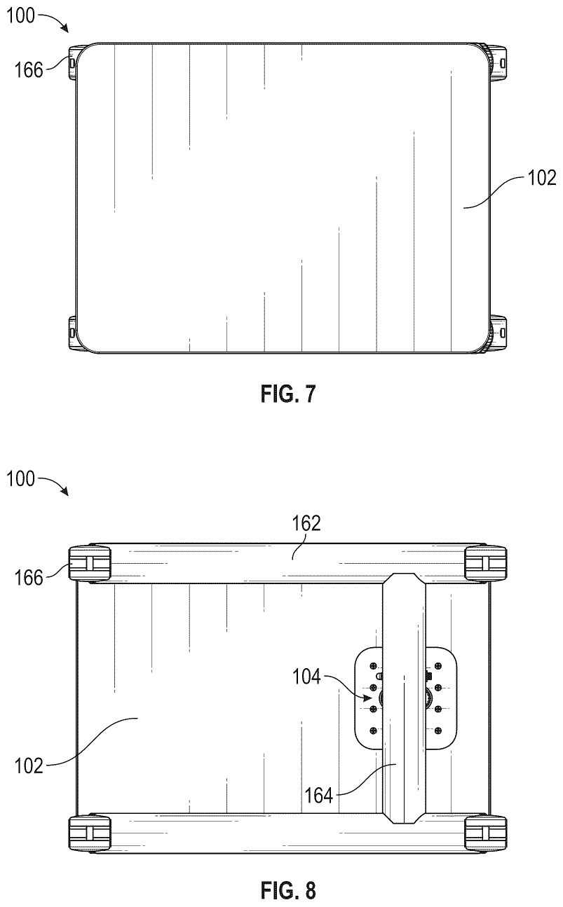

One embodiment of a clamp assembly 130 is demonstrated by FIGS. 9-13. The clamp assembly 130 can include a housing 131 (e.g., sleeve), a bracket 132, and/or a lever 136 (e.g., actuator). The housing 131 can be a sleeve that at least partially surrounds the connection between the upper leg 122 and the lower leg 124 of the leg assembly 120. The housing 131 may be shaped and/or sized to surround at least a portion of the upper leg 122 and the lower leg 124. The housing 131 may be fixedly attached and/or connected to the upper leg 122 of the leg assembly 120 such that the clamp assembly 130 moves with the upper leg 122. In some embodiments, the clamp assembly 130 may move and/or slide along an outer surface of the lower leg 124 as the upper leg 122 moves and/or slides along an outer surface of the lower leg 124. In some embodiments, the housing 131 may alternatively be fixedly attached and/or connected to the lower leg 124 of the leg assembly 120 such that the clamp assembly 130 does not move with the upper leg 122. The shape (e.g., interior shape) of the housing 131 can generally match the shape (e.g., exterior shape) of the upper leg 122 and/or the lower leg 124. In some embodiments, the housing 131 may have a cross section that varies in shape and size. For example, the housing 131 may have a first cross section shaped and sized to generally circumscribe the upper leg 122 and a second cross section shaped and sized to generally circumscribe the lower leg 124. However, any other combination of shapes and sizes of cross sections can be used for the housing 131.

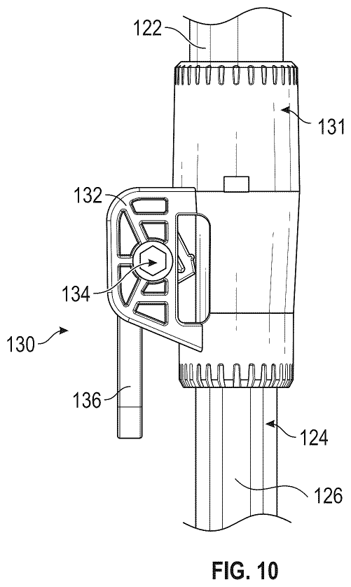

The housing 131 can include a shelf 142 (e.g., lip, projection, surface, etc.) where the clamp assembly 130 interfaces with the upper leg 122. FIG. 11 shows a side, cross-sectional view of an example embodiment of the clamp assembly 130 with the shelf 142 visible. In some embodiments, the shelf 142 may protrude inward from an inner surface of the housing 131. In some embodiments, the shelf 142 may extend about the entire inner circumference of the housing 131. In some embodiments the shelf 142 may be shaped and sized such that the upper leg 122 can at least partially sit or rest on the shelf 142. In some embodiments, the shelf 142 may be shaped and sized such that the upper leg 122 cannot move through the interior of the housing 131 beyond the shelf 142. This can advantageously prevent the upper leg 122 and the table member 102 from moving downward when the clamp assembly 130 is in a locked (e.g., engaged) position. In some embodiments, the shelf 142 may have a similar cross-sectional shape to the upper leg 122 with a smaller diameter than the upper leg 122.

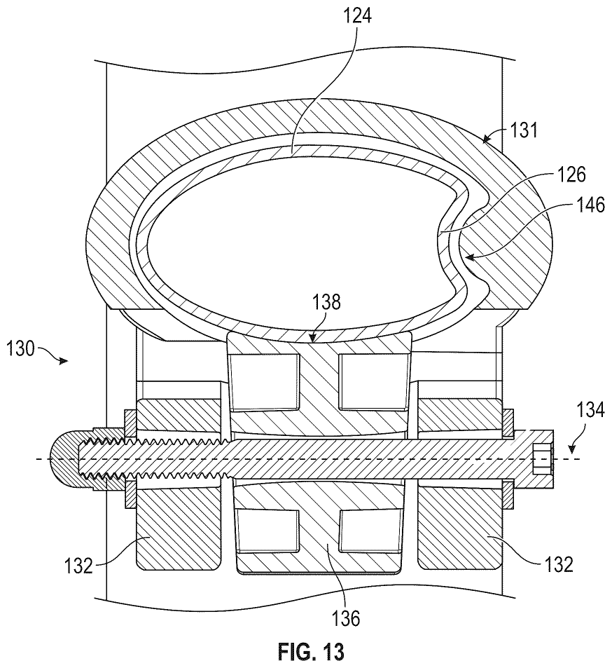

In some embodiments, the housing 131 of the clamp assembly 130 may include a protrusion 146. FIG. 13 illustrates a top, cross-sectional view of an example embodiment of the clamp assembly 130 with the protrusion 146 visible. The protrusion 146 may be shaped to at least partially occupy the groove 126 of the lower leg 124. The housing 131 may include more than one protrusion 146. The protrusion 146 may be positioned on the interior of the housing 131. The housing 131 may be positioned such that the protrusion 146 at least partially fits within the groove 126 of the lower leg 124. This may advantageously limit, substantially prevent, and/or prevent the upper leg 122, and thus the table member 102 from rotating as the height of the table 100 is adjusted.

The clamp assembly 130 can include a bracket 132 and lever 136 which, when actuated, can lock and/or unlock adjustment of the height of the table 100. In the embodiment shown in FIGS. 1A-14, the table 100 includes a pair of protrusions that form a bracket 132 to house a lever 136. In some embodiments, the bracket 132 and/or the lever 136 move with the clamp assembly 130 when the height of the table 100 is changed. The bracket 132 can allow the lever 136 to at least partially rotate about an axis 134 of the bracket 132. The lever 136 may be connected to the bracket 132 by a joint, bolt, pin, or other appropriate attachment mechanism that permits at least partial rotation of the lever 136. The axis 134 may be defined by a joint, bolt, pin, or other appropriate attachment mechanism that connects the lever 136 to the bracket 132.

The lever 136 can include a surface 138 (e.g., engagement surface, contact surface) to at least partially engage or press against a face (e.g., outer surface) of the lower leg 124. A user may rotate the lever 136 to a first “engaged” position such that the surface 138 contacts and/or engages with (e.g. presses against, contacts, touches) a portion of the lower leg 124. When the lever 136 is engaged, the table 100 can be “locked” such that adjustment of the height of the table member 102 is at least limited. FIG. 11 shows a side, cross-sectional view of an example embodiment of the lever 136 in the first “engaged” position. The surface 138 of the lever 136 may contact and/or engage with an outer surface of the lower leg 124 in the first “engaged” position, creating a frictional force between the surface 138 and an outer surface of the lower leg 124 which may advantageously resist or substantially prevent vertical movement of the clamp assembly 130 relative to the lower leg 124, for example, by resisting or substantially preventing the clamp assembly 130 from moving and/or sliding along the outer surface of the lower leg 124. This frictional force created between the surface 138 and an outer surface of the lower leg 124 when the lever 136 is in the “engaged” position may resist or substantially prevent vertical movement of the upper leg 122, and thus the table member 102, relative to the lower leg 124 due to the connection between the upper leg 122 and the clamp assembly 130. Thus, in some embodiments, when the lever 136 of the clamp assembly 130 is in the “engaged” position, the frictional force between the surface 138 and the outer surface of the lower leg 124 resists or substantially prevents adjustment of the height of the table member 102.

Alternatively, or in addition to the frictional force between the surface 138 of the lever 136 and the lower leg 124, adjustment of the height of the table member 102 may also be resisted or substantially prevented by a frictional force between the upper leg 122 and the lower leg 124 when the lever 136 is in the “engaged” position. In some embodiments, when the lever 136 is in the first “engaged” position, the lever 136 pushes against the lower leg 124 such that an outer surface of the lower leg 124 is pushed against an inner surface of the upper leg 122, for example, on a side of the leg assembly 120 opposite the lever 136. This may advantageously create a frictional force between an outer surface of the lower leg 124 and an inner surface of the upper leg 122 which resists or substantially prevents vertical movement of the upper leg 122, and thus the table member 102, relative to the lower leg 124, for example, by resisting or substantially preventing the upper leg 122 from moving and/or sliding along the outer surface of the lower leg 124. Thus, in some embodiments, when the lever 136 of the clamp assembly 130 is in the “engaged” position, the frictional force between the outer surface of the lower leg 124 and the inner surface of the upper leg 122 resists or substantially prevents adjustment of the height of the table member 102.

In some embodiments, when the lever 136 is in the “engaged” position, a portion of the housing 131 on a side of the clamp assembly 130 opposite the lever 136 is pulled toward the lever 136. When the portion of the housing 131 is pulled toward the lever 136, the housing 131 may contact and push on the upper leg 122 such that an inner surface of the upper leg 122 is pushed against an outer surface of the lower leg 124 on a side of the leg assembly opposite the lever 136, creating or increasing a frictional force between the inside surface of the upper leg 122 and the outside surface of the lower leg 124. Increasing the frictional force between the upper leg 122 and the lower leg 124 may advantageously increase the force required to overcome the frictional force and inadvertently change the height of the table member 102 while the lever 136 is in the “engaged” position.

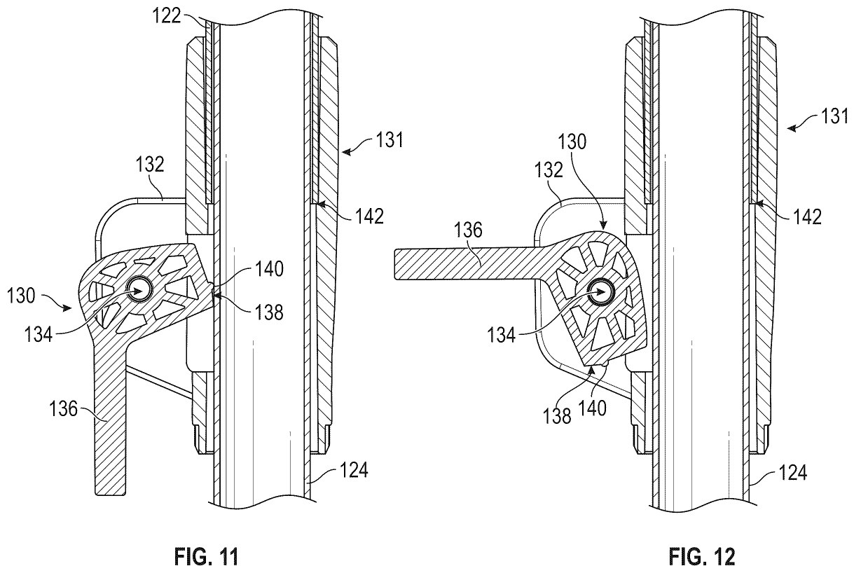

A user may rotate the lever 136 to a second “disengaged” position where friction between: the lever 136 and the lower leg 124 and/or the upper leg 122 and the lower leg 124 is substantially reduced or eliminated, freely allowing adjustment of the height of the table 100. FIG. 12 depicts a side, cross-sectional view of an example embodiment of the lever 136 in the “disengaged” position. When disengaged, the surface 138 may no longer contact the leg assembly 120. In some embodiments, the surface 138 may still at least partially contact an outside surface of the lower leg 124 when the lever 136 is in the “disengaged” position. In some embodiments, the lever 136 can be lifted (e.g., upward) to transition the lever 136 to the “disengaged” position and/or the lever can be lowered (e.g., downward) to transition the lever 136 to the “engaged” position.

In some embodiments, the surface 138 can be angled relative to the outer surface of the lower leg 124 when the lever 136 is in the “engaged” position. For example, the surface 138 can be angled up and away from the outer surface of the lower leg 124 such that an upper portion of the surface 138 does not contact or exerts a lesser force on the lower leg 124 while a lower portion of the surface 138 contacts or exerts a greater force on the lower leg 124. Angling the surface 138 up and away from the lower leg 124 in the “engaged” position may increase the amount (e.g., degree) of lever 136 rotation needed to fully disengage (e.g., stop contacting) the lower leg 124 with the surface 138. This may reduce the risk of the table 100 accidentally transitioning to the “disengaged” position due to external forces without user interaction with the lever 136.

FIGS. 1A-1C illustrate an example embodiment of the table 100 in operation. FIG. 1A shows the table 100 at an initial height in the “locked” position where the lever 136 is in the “engaged” position. In this “locked” position, the height of the table may be maintained while the table is in use due to the frictional force(s) created by the lever 136 engaging with the lower leg 124. To adjust the height of the table, the user rotates the lever 136 of the clamp assembly 130 to the “disengaged” position, placing the table in the “unlocked” position as shown in FIG. 1B. In this position, the height of the table member 102 can be adjusted to a preferred height, as the frictional force(s) created by the lever 136 engaging the lower leg 124 are substantially removed. Once a user moves the table member 102 to the desired height, they may then rotate the lever 136 back to the “engaged” position, placing the table 100 in the “locked” position at a new height as shown in FIG. 1C.

In some embodiments, the clamp assembly 130 may not require any screws to assist in tightening the clamp assembly 130. In some embodiments, the clamp assembly 130 may not require any bolt to lock the lever 136 in position. In some embodiments, the lever 136 of the clamp assembly 130 may be maintained in its “engaged” position solely by frictional force. In some embodiments, the lever 136 can be maintained in its first engaged position at least partially by a detent 140 (e.g., protrusion) formed on a portion of the surface 138, as described herein.

In some embodiments, the frictional force created by the clamp assembly 130 between the upper leg 122 and lower leg 124 is the sole force maintaining or “locking” the table member 102 at its current height. This may advantageously decrease the complexity of the table 100 in comparison to conventional adjustable height tables which require use of more complex or involved systems to maintain the height of the table, such as stop pins inserted fully through a leg to lock a table member at a particular height, snap springs which expand into holes along the legs, pneumatic cylinders with gas valves, or motors with mechanical breaks. This simplified clamping system may thus reduce the potential cost and risk of malfunction of the table 100. Utilizing solely frictional force to hold the table 100 at a particular height may allow the height of the table 100 to be continuously adjustable, rather than conventional systems which typically can only limit height of the tables at a preset number of height settings. This may advantageously allow a user a great deal of control over their preferred table height setting.

In some embodiments, the lever 136 may comprise the detent 140 (e.g., protrusion). In some embodiments, the detent 140 may be positioned on the surface 138 of the lever 136 that contacts the leg assembly 120. In some embodiments, the detent 140 may be a protrusion. In some embodiments, as the lever 136 is rotated to the “engaged” position, the detent 140 or any portion of the clamp assembly 130 may need to be partially deformed as the detent 140 presses against the lower leg 124. In some embodiments, the detent 140 may be pressed against an outer surface of the lower leg 124 when the lever 136 is in the first “engaged” position. In some embodiments, the detent 140 and the surface 138 may simultaneously contact the lower leg 124 when the lever is in the first “engaged” position. This may advantageously increase the frictional force between the lever 136 and the lower leg 124, thereby increasing the amount of force required to overcome the frictional force and inadvertently change the height of the table member 102 while the lever 136 is in the “engaged” position. In some embodiments, the detent 140 may also advantageously provide users with tactile, visual, and/or auditory feedback to inform the user when they have fully rotated the lever 136 to the “engaged” position.

In some embodiments, one or more portions of the lever 136 (e.g., the surface 138 and/or the detent 140) can be formed of a deformable material. The lever 136 can be sized, shaped, and/or positioned relative to the leg assembly 120 (e.g., the lower leg 124) such that the lever 136 must at least partially deform in order to transition between the “engaged” and “disengaged” positions. This may increase the force required to move the lever 136 between the “engaged” and “disengaged” positions, thereby reducing the risk of the table 100 accidentally transitioning to the “disengaged” position due to external forces. This may additionally or alternatively provide the user with tactile feedback when the lever is transitioned between the “engaged” and “disengaged” positions.

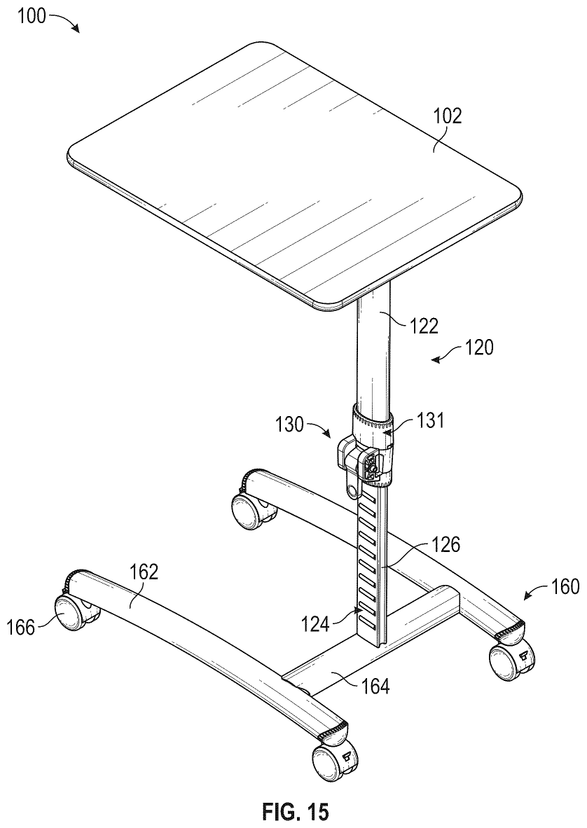

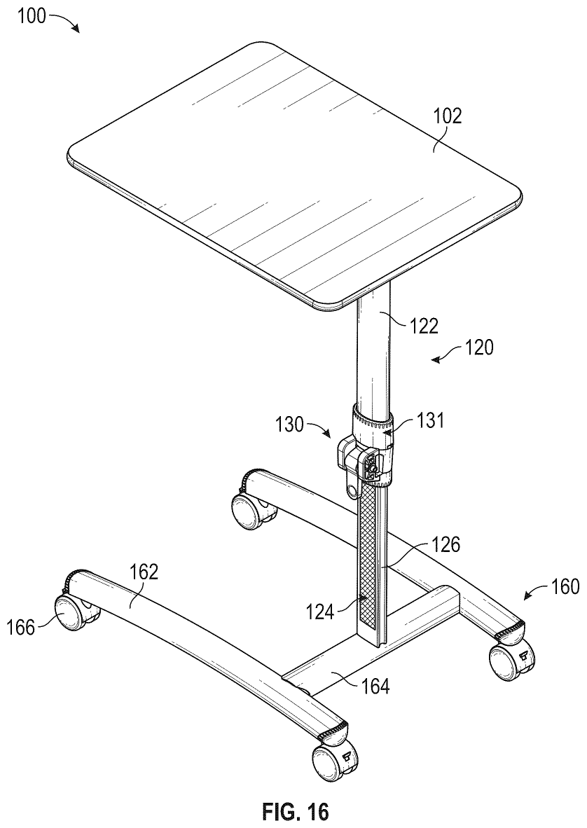

In some embodiments, the portion of the lower leg 124 that contacts the lever 136 can be coated with or can be made of materials to increase the coefficient of friction between the lever 136 and the lower leg 124 when the lever 136 is in the engaged position. In some embodiments, the lever 136 and/or the surface 138 may be made of nylon. In some embodiments, the surface 138 of the clamp assembly 130 and/or an outside surface of the lower leg 124 may include one or more surface features and/or roughened textures in order to increase the frictional force between the surface 138 and an outside surface of the lower leg 124. For example, in the embodiment shown in FIG. 16, an outer surface of the lower leg 124 has a rough texture. Adding a surface feature and/or rough texture(s) to an outside surface of the lower leg 124 may also advantageously increase the frictional force between the outside surface of the lower leg 124 and an inside surface of the upper leg 122. In some embodiments, the surface of the clamp assembly 130 and/or the surface of the lower leg 124 may comprise notches or ridges to increase the frictional force between the surface 138 and an outside surface of the lower leg 124. For example, in the embodiment shown in FIG. 15, an outer surface of the lower leg 124 has ridges along the surface where the lower leg 124 would contact the lever 136. Increasing the coefficient of friction and/or the frictional force may advantageously increase the force necessary to inadvertently change the height of the table 100 while the clamp assembly is in the “engaged” position.

In some embodiments, the clamp assembly 130 is the sole mechanism for maintaining or “locking” the table member 102 at its current height. This may advantageously reduce the complexity of the table 100, thereby reducing the potential cost and risk of malfunction of the table 100. It may also advantageously increase ease of use for a user by providing a single adjustment point for “locking” or “unlocking” the height of the table. Furthermore, the clamp assembly 130 may not require any motors, pneumatics, or electronics which may further reduce the cost and risk of malfunction of the table 100, in addition to reducing the potential weight of the table 100.

### Retention Assembly

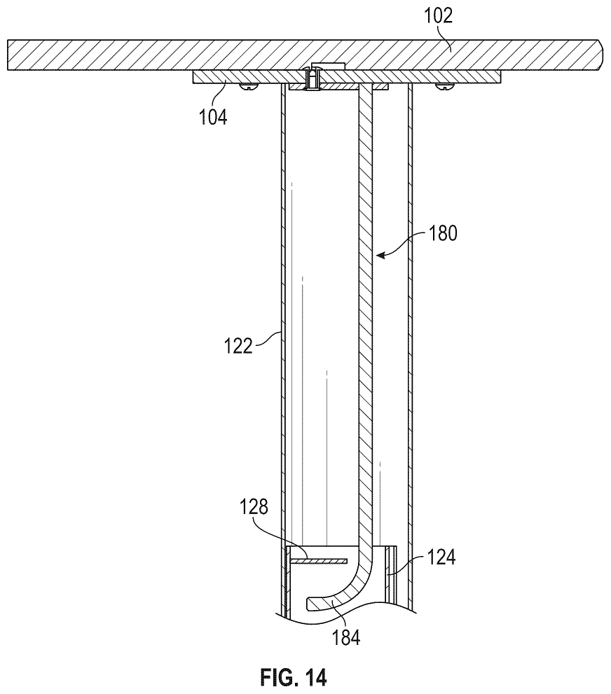

In some embodiments, the table 100 may include a retention assembly 180 to limit the maximum vertical movement of the table member 102. This may advantageously prevent the upper leg 122 from being easily detached from the lower leg 124. This may occur if the table member 102 were raised to a height where the upper leg 122 would no longer contact the lower leg 124. FIG. 14 shows a side, cross-sectional view of an example embodiment of the retention assembly 180. In some embodiments, the retention assembly 180 may be fixedly attached and/or connected to the table member 102 or the upper leg 122 such that the retention assembly 180 moves with the table member 102 as the height of the table member 102 is adjusted. The retention assembly 180 may be connected to the table member 102 or the upper leg 122 by welding, mechanical fastening such as use of a threaded fastener, or any other appropriate means. In some embodiments, the retention assembly 180 may be connected to the table member 102 by an attachment plate 104. In some embodiments, the retention assembly 180 can be positioned at least partially within the leg assembly 120 to reduce the footprint of the retention assembly 180.

In some embodiments, the retention assembly 180 may extend vertically downward from the table member 102 or the upper leg 122 toward the lower leg 124. The retention assembly 180 may extend within the leg assembly 120. The retention assembly may include a hook 184 (e.g., hooking member, protrusion) that can catch and/or latch onto a projection 128 of the leg assembly 120 when the table member 102 is raised to a maximum height to prevent accidental further upward movement of the table member 102. The retention assembly 180 may be shorter than the length of the upper leg 122. This may advantageously allow the hook 184 of the retention assembly 180 to catch onto a portion of the leg assembly 120 and stop the upward movement of the table member 102 before the upper leg 122 travels beyond the length of the lower leg 124.

In some embodiments, the leg assembly 120 may include the projection 128 that extends into an interior of the leg assembly 120 in order to catch and/or prevent the hook 184, and thus the table member 102, from further upward movement when the table member 102 is raised to a maximum height. The projection 128 may be fixedly attached and/or connected to the lower leg 124. The projection 128 may be integrally formed with the lower leg 124. The projection 128 may be connected to the lower leg 124 near a top end of the lower leg 124. The hook 184 may curve toward the projection 128 to allow the hook 184 to more easily catch onto the projection 128.

In some embodiments, the positioning and/or orientation of the retention assembly 180 and the projection 128 can be substantially reversed. For example, the retention assembly 180 (e.g., hook 184 thereof) can be stationary while the projection 128 moves with the upper leg 122 and table member 102. The retention assembly 180 can be fixedly attached and/or connected to the frame 160 or the lower leg 124 such that the retention assembly 180 does not move with the table member 102 as the height of the table member 102 is adjusted. The retention assembly 180 may be connected to the frame 160 or the lower leg 124 by welding, mechanical fastening such as use of a threaded fastener, or any other appropriate means. The retention assembly 180 may extend vertically upwards from the frame 160 or the lower leg 124 toward the upper leg 122. The projection 128 can be coupled to and/or integral with the upper leg 122 such that the projection 128 moves with the upper leg 122 and table member 102, rather than the retention assembly 180 (e.g., hook 184). The projection 128 can contact (e.g., catch) the hook 184 when the table member 102 is raised to a maximum height to prevent further upward movement of the table member 102 and upper leg 122. The projection 128 can be positioned proximate a lower end of the upper leg 122.

### Frame

In some embodiments, the table 100 and the leg assembly 120 may be supported by a frame 160. The frame 160 may include one or more feet 162 to stabilize the table 100. The one or more feet 162 may extend outward away from the leg assembly 120 to provide a wider base of support for the table 100. In some embodiments, the feet 162 may be linear or nonlinear. For example, the frame 160 may include two linear feet 162 and/or a singular foot 162 with a circular shape. In some embodiments, the one or more feet 162 may be fixedly attached and/or connected to the leg assembly 120. The one or more feet 162 may extend to a length of the table member 102 to provide support for weight placed on the table member 102. In some embodiments, the one or more feet 162 may extend beyond a length of the table member 102 to increase the stability of the table 100 by providing a wider base of support. Advantageously, the center of gravity of the table member 102 can be positioned to be generally within the perimeter defined by the frame 160.

In some embodiments, the frame 160 may include a support member 164. The support member 164 can connect the leg assembly 120 to the one or more feet 162. In some embodiments, the support member 164 may connect one or more feet 162 to each other which may advantageously add rigidity and/or stability to the frame 160. In some embodiments, the support member 164 may join two feet 162 to form an H-shape. In some embodiments, the frame 160 may include more than one support member 164. The support member 164 may extend to a width of the table member 102 to provide support for weight placed on the table member 102. The support member 164 may extend beyond a width of the table member 102 to increase the stability of the table 100 by providing a wider base of support.

The frame 160 may include one or more wheels 166 to permit the table 100 to roll in order to make transportation of the table 100 easier. The frame 160 may include no wheels. In some embodiments, the one or more wheels 166 may be fixedly attached and/or connected to one or more feet 162. The one or more wheels 166 may be connected to the one or more feet 162 near ends of the one or more feet 162 which may advantageously increase the stability of the frame 160 and the table 100 by spreading out the points at which the one or more wheels 166 contact the ground.

In the embodiment shown in FIGS. 1A-16, the support member 164 of the table 100 is connected at each end to two feet 162. The feet 162 extend in a substantially perpendicular direction to the support member 164 such that the feet 162 and the support member 164 form a generally H-shape. The support member 164 extends in a substantially parallel direction to a width of the generally rectangular table member 102. The support member 164 is a similar length to the width of the generally rectangular table member 102. The leg assembly 120 is connected to the table member 102 near a center point of the width of the table member 102. The leg assembly 120 is connected to the support member 164 near a center point of the support member 164 such that the two feet 162 are positioned to be generally parallel to and collinear with the length of the generally rectangular table member 102. This may advantageously increase the stability of the table 100 by providing support for the table member 102 along the perimeter of its longer sides. The support member 164 can connect the two feet 162 at a point offset from a center point of the feet 162 toward one end of the feet 162. Offsetting the position of the support member 164 toward one end of the feet 162 may advantageously provide more open space under the table member 102 to allow a user to more easily fit a chair or their legs underneath the table. The table 100 can further include four wheels 166 with one wheel connected to each end of each foot 162 which may advantageously increase the ease with which the table 100 may roll.

In some embodiments, the table member 102 and/or leg assembly 120 can be rotated relative to the frame 160. This may advantageously allow a user easier access to the sides of the table 100 and/or may change the footprint of the table 100 to more easily fit into certain spaces.

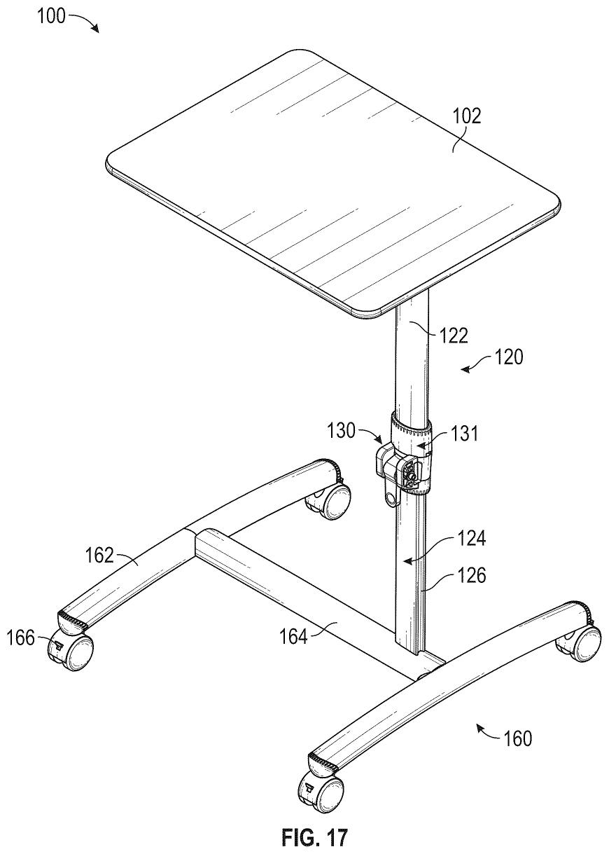

FIG. 17 illustrates an alternative embodiment of the table 100 where the frame 160 is rotated (e.g., approximately 90 degrees) relative to the table member 102 and the leg assembly 120. The feet 162 can extend in a substantially perpendicular direction to the support member 164 such that the feet 162 and the support member 164 form a generally H-shape. The support member 164 can extend in a substantially parallel direction to a length of the generally rectangular table member 102. The support member 164 can be of a similar length to the length of the generally rectangular table member 102. The leg assembly 120 can be connected to the table member 102 offset from a center point of the length of the table member 102. The leg assembly 120 can be connected to the support member 164 offset from a center of the support member 164 such that the two feet 162 are positioned to be generally parallel to and collinear with the width of the generally rectangular table member 102. This may advantageously increase the stability of the table 100 by providing support for the table member 102 along the perimeter of its shorter sides. The support member 164 can connect the two feet 162 near a center of the feet 162 such that the support member 164 is positioned substantially beneath a center line of the width of the table member 102. This may advantageously increase the stability of the table 100 by providing support for the table member 102 along its center line.

### Additional Considerations

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise,” “comprising,” and the like, are to be construed in an inclusive sense as opposed to an exclusive or exhaustive sense, that is to say, in the sense of “including, but not limited to.”

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims.

What is claimed is:

1. A table comprising:
a table member;
a telescoping leg assembly comprising:
a lower leg coupled to a frame to support the table; and
an upper leg coupled to the table member, the upper leg configured to move along an axis defined by the lower leg to adjust a height of the table member, the upper leg configured to at least partially surround the lower leg as the upper leg is moved along the axis; and
a clamp assembly comprising:
a housing coupled to the upper leg, wherein the housing at least partially surrounds the upper leg and the lower leg; and
a lever coupled to the housing, the lever selectively rotatable between an engaged position and a disengaged position;
wherein the upper leg and the table member are freely movable along the axis when the lever is in the disengaged position,
wherein movement of the upper leg and the table member is resisted along the axis when the lever is in the engaged position.

2. The table of claim 1, wherein an engagement surface of the lever further comprises a protrusion configured to contact an outer surface of the lower leg when the lever is rotated to the engaged position, wherein the protrusion further resists movement of the upper leg and table member along the axis.

3. The table of claim 1, wherein the clamp assembly simultaneously presses the lower leg against the upper leg and pulls the upper leg against the lower leg when the lever is in the engaged position to resist movement of the upper leg and table member along the axis.

4. The table of claim 1, wherein the table member and upper leg are configured to move along the axis without motors, electronics, or pneumatics.

5. The table of claim 1, wherein, when the lever is in the engaged position, a position of the table member is maintained solely by frictional force between: the upper leg and the lower leg; and the lever and the lower leg.

6. The table of claim 1, further comprising a retention assembly configured to engage a portion of the lower leg to limit a maximum vertical movement of the table member.

7. The table of claim 6, wherein the retention assembly comprises a hook configured to move with the table member and upper leg, the hook configured to catch a protrusion of the lower leg to limit the maximum vertical movement of the table member.

8. The table of claim 1, wherein the lower leg comprises a groove extending along a length of the lower leg, and the housing comprises a housing protrusion configured to be received in the groove to limit rotational movement between the upper leg and the lower leg.

9. A table comprising:
a table member;
a telescoping leg assembly comprising:
a first leg coupled to the table member; and
a second leg coupled to a support frame, the second leg shaped and sized to at least partially fit within the first leg as the first leg moves relative to the second leg; and
a locking assembly comprising:
a sleeve configured to at least partially surround the first leg and the second leg; and
an lever coupled to the sleeve, the lever movable between an engaged and a disengaged position;
wherein the first leg and the second leg are freely movable relative to each other when the lever is in the disengaged position, and
wherein relative movement between the first leg and the second leg is prevented when the lever is in the engaged position to set a height of the table.

10. The table of claim 9, wherein the lever comprises an engagement surface comprising a detent mechanism, the engagement surface and detent mechanism configured to contact an outer surface of the second leg when the lever is in the engaged position to prevent relative movement between the first leg and the second leg.

11. The table of claim 10, wherein the second leg comprises a plurality of surface features configured to contact the engagement surface and the detent mechanism when the lever is in the engaged position to increase a frictional force between the second leg and the lever.

12. The table of claim 9, wherein the locking assembly simultaneously presses the second leg against the first leg and pulls the first leg against the second leg when the lever is in the engaged position to prevent relative movement between the first leg and the second leg.

13. The table of claim 9, further comprising a retention assembly configured to limit a maximum height of the table, the retention assembly configured to move with either the first leg or the second leg and configured to engage with a portion of the other of the first leg or the second leg when the table is moved to the maximum height to prevent further movement of the first leg and the second leg away from each other.

14. The table of claim 10, wherein the first leg comprises a groove extending along a length of the second leg, and the sleeve comprises a sleeve protrusion configured to be received in the groove to limit rotational movement between the second leg and the first leg.

15. An adjustable height furniture comprising:
a telescoping leg assembly configured to adjust a height of the furniture, the telescoping leg assembly comprising:
a first leg; and
a second leg; and
a locking assembly comprising:
a housing coupled to the second leg; and
an lever movable between an engaged position and a disengaged position;
wherein the first leg and the second leg are free to move relative to each other when the lever is in the disengaged position, and
wherein relative movement between the first leg and the second leg is prevented when the lever is in the engaged position.

16. The furniture of claim 15, wherein the lever comprises an engagement surface configured to contact an outer surface of the second leg when the lever is in the engaged position to prevent relative movement between the first leg and the second leg.

17. The furniture of claim 16, wherein the engagement surface comprises a protrusion configured to contact the outer surface of the second leg when the lever is in the engaged position to prevent relative movement between the first leg and the second leg.

18. The furniture of claim 15, wherein the locking assembly simultaneously presses the second leg against the first leg and pulls the first leg against the second leg when the lever is in the engaged position to prevent relative movement between the first leg and the second leg.

19. The furniture of claim 15, further comprising a retention assembly configured to limit a maximum height of the furniture, the retention assembly configured to move with either the first leg or the second leg and configured to engage with a portion of the other of the first leg or the second leg when the furniture is moved to the maximum height to prevent further movement of the first leg and the second leg away from each other.

20. The furniture of claim 15, wherein the first leg comprises a groove extending along a length of the second leg, and the housing comprises a housing protrusion configured to be received in the groove to prevent rotational movement between the second leg and the first leg.
